(19) United States
(12) Patent Application Publication
(10) Pub. No.: US 2018/0095975 A1
(43) Pub. Date: Apr. 5, 2018

(54) MANAGING FILE FORMATS

(71) Applicant: HEWLETT PACKARD ENTERPRISE DEVELOPMENT LP, Houston, TX (US)

(72) Inventor: Stuart McLaren, Galway (IE)

(21) Appl. No.: 15/282,081

(22) Filed: Sep. 30, 2016

(51) Int. Cl. G06F 17/30; G06F 9/455

(52) U.S. Cl. CPC G06F 17/30076; G06F 2009/45583; G06F 2009/4557; G06F 9/45558

(57) ABSTRACT

Examples relate to managing file formats. In one example, a computing device may identify a particular file having a first format; generate a reference file for a second format of the particular file, the reference file including i) metadata for the second format of the particular file, and ii) at least one reference to a location of data included in the particular file; and generate, for the particular file, a file map that identifies the first format as a base file for the particular file.

### BACKGROUND

Computing devices store and use data in a variety of different ways and in a variety of different formats. A file format is a way in which data is encoded for storage in a computer file. For some files, the same type data may be capable of being stored in a variety of different formats. The different formats may have different features, information, and compatible software and/or hardware. For example, a digital document may be stored in many different formats, each format storing the same underlying information but with different encoding.

### BRIEF DESCRIPTION OF THE DRAWINGS

The following detailed description references the drawings, wherein:

FIG. 1 is a block diagram of an example computing device for managing file formats.

FIG. 2 is an example data flow depicting the management of file formats.

FIG. 3 is a flowchart of an example method for managing virtual machine image file formats.

FIG. 4 is a flowchart of an example method for the management of file formats.

### DETAILED DESCRIPTION

Reference files may be used when storing different formats of data to reduce the amount of data storage space used for storing multiple formats of the same file. For example, a particular file with multiple formats may be stored once, in a base format, and reference files may be created for each other format to be stored. The reference files may each include references to the base format and metadata that describes various aspects of the corresponding format. The references to the base format may include, for example, pointers to the location where data from the base format is stored.

By way of example, a virtual machine image file manager may manage storage and distribution of virtual machine image files. Virtual machine images include data used by a computing device to deploy and run an operating system using the physical resources of the underlying computer device. These image files are often relatively large, and include a variety of information specific to the type of virtual machine to be deployed. A virtual machine image manager may provide many different types virtual machine images and configurations, and images may be used to store many of the image files for the various virtual machine configurations. Virtual machine image files may often be requested in various different formats for a variety of reasons, such as compatibility or preference.

To reduce the storage space that would be used by storing multiple copies of a virtual machine image file, e.g., one in each format, the virtual machine image file manager may use reference files. For example, the file manager may select one image file format and its underlying data as a base file or base format for a particular type of virtual machine image. The base image file may be stored in its entirety using data storage available to the file manager. To store a second format for that same virtual machine image, the file manager may create a reference file for the second format. The reference file may include any metadata relevant to the second format, such as a header and/or footer that includes data enabling the recipient of the metadata to use the image file in the second format. The reference file also includes references, such as pointers, to the location where data is stored for the base file. A separate mapping file may, in some implementations, be used to identify the base file for each virtual machine image stored by the virtual machine image file manager.

During operation, the virtual machine image file manager may receive a request for a particular virtual machine image file in a particular format. A base file for the requested virtual machine image file is identified, e.g., using a mapping file. In situations where the request is for the base format of the virtual machine image, the base file may be provided in response to the request. In a situation where the request is for a format that is not the base format, the reference file is used to respond to the request. When using the reference file to respond to the request, the virtual machine image file manager may send any metadata for the requested format that is included in the reference file and use the references included in the reference file to provide the underlying data stored for the base file. As reference files include metadata and references/pointers, rather than a copy of all of the underlying virtual machine image data, storage space used for each additional format of a virtual machine image may be reduced. In addition, the references may vitiate the need to perform data conversions, which may reduce computing resources required to provide multiple formats of a given virtual machine image file. These and other similar techniques may be used to store a variety of files that have multiple formats, and further details regarding the management of file formats are provided in the paragraphs that follow.

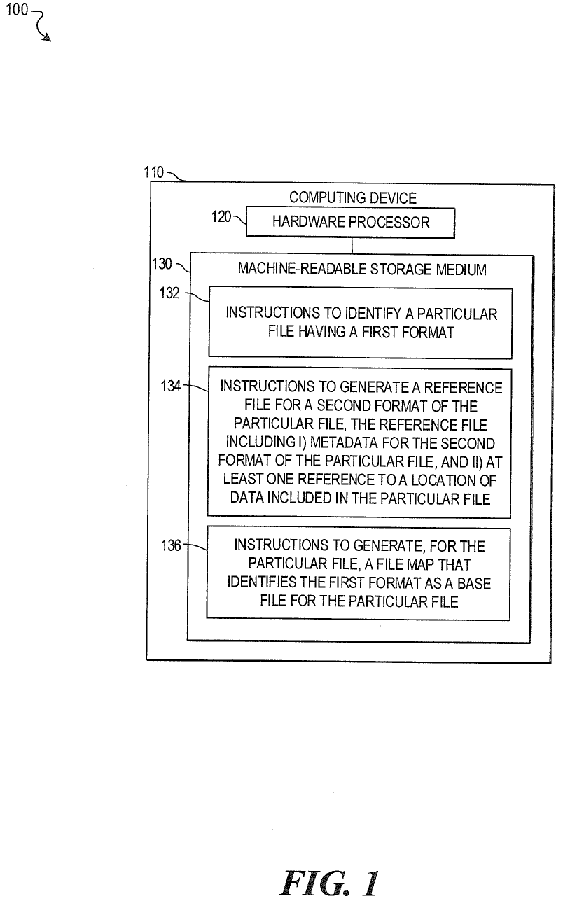

Referring now to the drawings, FIG. 1 is a block diagram 100 of an example computing device 110 for managing file formats. Computing device 110 may be, for example, a personal computer, a server computer, cluster of computers, or any other similar electronic device capable of processing data. In the example implementation of FIG. 1, the computing device 110 includes a hardware processor, 120, and machine-readable storage medium, 130.

Hardware processor 120 may be one or more central processing units (CPUs), semiconductor-based microprocessors, and/or other hardware devices suitable for retrieval and execution of instructions stored in machine-readable storage medium, 130. Hardware processor 120 may fetch, decode, and execute instructions, such as 132-136, to control processes for managing file formats. As an alternative or in addition to retrieving and executing instructions, hardware processor 120 may include one or more electronic circuits that include electronic components for performing the functionality of one or more instructions, e.g., a Field Programmable Gate Array (FPGA) or Application Specific Integrated Circuit (ASIC).

A machine-readable storage medium, such as 130, may be any electronic, magnetic, optical, or other physical storage device that contains or stores executable instructions. Thus, machine-readable storage medium 130 may be, for example, Random Access Memory (RAM), non-volatile RAM (NVRAM), an Electrically Erasable Programmable Read-Only Memory (EEPROM), a storage device, an optical disc, and the like. In some implementations, storage medium 130 may be a non-transitory storage medium, where the term “non-transitory” does not encompass transitory propagating signals. As described in detail below, machine-readable storage medium 130 may be encoded with executable instructions 132-136, for managing file formats.

As shown in FIG. 1, the hardware processor 120 executes instructions 132 to identify a particular file having a first format. The types of files and formats may vary. In some implementations, the particular file is a virtual machine image file and the first format is a raw format, e.g., uncompressed image data. Other virtual machine formats may be, for example, qcow2, vhd, vmdk, or vdi. The particular file and format may be provided by a separate device or identified within a storage device, such as the machine-readable storage medium 130 or a separate storage device.

The hardware processor 120 executes instructions 134 to generate a reference file for a second format of the particular file, the reference file including i) metadata for the second format of the particular file, and ii) at least one reference to a location of data included in the particular file. The metadata may include a variety of information relevant to the second format and, in some implementations, may include a header and/or a footer for the reference file. Using the virtual machine image file example, a reference file may be created for the same virtual machine image file, but in the qcow2 format, which is different from the raw format. The metadata for the qcow2 format may include, for example, a header file that specifies information used by a host computing device hypervisor to deploy a virtual machine. The qcow2 reference file may also include references, e.g., pointers, to the location in a data storage device of the raw format data. For example, in a situation where the raw format data is stored at memory addresses X, Y, and Z, the qcow2 reference file may include pointers to memory addresses X, Y, and Z. In some situations, a single reference to a single memory address or memory address range may be used in a reference file.

The hardware processor 120 executes instructions 136 to generate, for the particular file, a file map that identifies the first format as a base file for the particular file. In the example above, the raw format may be identified as the base file for the particular virtual machine image file. A file map may be used to facilitate the identification of the location at which the data included in the base file is stored, enabling retrieval of the data using the references included in the reference files.

In some implementations, the hardware processor 120 may execute instructions to receive a request for the particular file in the first format or the second format. Using the virtual machine image file example, a request may be received for the particular virtual machine image in raw format or qcow2 format. The base file for the particular file—the virtual machine image file in this example—is identified using the file map. In the example above, the raw format is the base file for the particular virtual machine image that was requested.

In a situation where the request is for the first format, e.g., the base format, the data included in the base file may be provided in response to the request. For example, a request for the raw format of the particular virtual machine image file may result in providing the raw format in response. In a situation where the request is for the second format, e.g., the qcow2 format, the data included in base file may be obtained using the reference(s) included in the reference file, and both the metadata for the second format and the data obtained from the base file may be provided in response to the request. For example, a request for the qcow2 format of the particular virtual machine image file may result in obtaining the data from the base file using the references in the qcow2 reference file and providing the header from the qcow2 reference file as well as the obtained data.

The reference file and file map generated by the computing device 110 are designed to facilitate storage and provision of files with multiple formats. Using references, rather than storing copies of all data, reduces storage space used when storing multiple file formats. In addition, performing the aforementioned file format management processes may use less computer resources than other processes designed to reduce the use of computer storage or de-duplicate data, which may often involve computationally expensive data comparisons and compression algorithms. Using the processes described above, files may be provided directly to a requestor in multiple formats, without using on-the-fly format conversions or other similar processes that may cost additional time and computing resources.

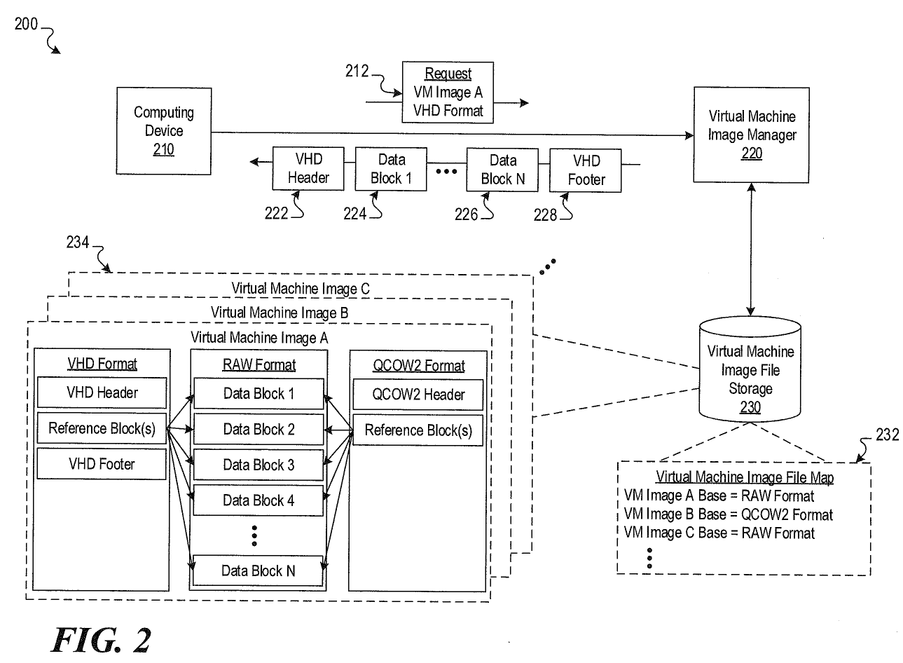

FIG. 2 is an example data flow 200 depicting the management of file formats. The example data flow 200 depicts the various aspects of virtual machine image file format management in particular. The same or similar implementations may be used for managing file formats for other types of files as well. The example data flow 200 includes a computing device 210, a virtual machine image manager 220, and virtual machine image file storage 230. The virtual machine image manager 220 may be the same as or similar to the computing device 110 of FIG. 1. The computing device 210 may be any computing device capable of communicating with the virtual machine image manager 220, such as a host computing device for operating one or more virtual machines. The virtual machine image file storage 230 is a data storage device for storing virtual machine image files and other data related to virtual machine image file formats. While the example data flow 200 depicts three devices, other implementations may include multiple devices of various types. For example, in a cloud computing system designed to distribute virtual machines to many different devices in many different formats, many computing devices may make use of multiple virtual machine image management devices in a distributed system that may use multiple virtual machine image file storage devices.

In the example data flow 200, the virtual machine image file storage 230 stores multiple virtual machine images 234, and the virtual machine images may be stored in one format, e.g., a base format, with reference files for other formats of the virtual machine image file. For example, virtual machine image A has a base file in a raw format, where data blocks 1 through N include the data for the virtual machine image A file. Reference files are also stored for two other formats of virtual machine image A, a vhd format and a qcow2 format. The vhd reference file includes metadata—the vhd header and vhd footer—which includes information relevant to the vhd format, such as data that may be used by a device to deploy virtual machine image A in the vhd format. The vhd file also includes one or more reference blocks that reference the underlying data for virtual machine image A, which is stored in the raw format. The references may include, for example, pointers to locations in memory or a range of memory addresses at which data blocks 1 through N are stored. Similarly, the qcow2 reference file includes metadata for the qcow2 format and reference blocks that reference data blocks 1 through N.

During operation, the computing device 210 sends a request 212 to the virtual machine image manager 220. The request 212 is for a particular virtual machine image file called “VM Image A” in the vhd format. The virtual machine image manager 220 receives the request 212 and identifies a base file for VM Image A using a file map 232 stored in virtual machine image file storage 230. According to the example file map 232, the base file for VM Image A is the raw format version of VM Image A.

The virtual machine image manager 220 identifies the reference file associated with the request 212, which in this example is the vhd reference file for Virtual Machine Image A. The virtual machine image manager 220 may then provide the requested data to the computing device 210 using the vhd reference file. For example, and as depicted in the example data flow 200, the virtual machine image manager 220 may stream the requested image file to the computing device. The virtual machine image manager 220 reads the vhd reference file and provides the vhd header 222. When preparing to stream the remainder of the image file in vhd format, the virtual machine image manager 220 reads the reference blocks, obtains the data blocks 1 though N referenced by memory addresses included in the reference blocks, and streams data blocks 1 224 through data block N 226 to the computing device 210. The example vhd reference file ends with a vhd footer 228, which is also streamed from the vhd reference file to the computing device 210.

The example data flow 200 depicts one example of managing file formats using the processes described above. Many other types of files having multiple formats may be managed in a similar manner. While three separate devices are depicted in the example data flow 200, other implementations may include more or less devices, with operations separated between additional devices and/or combined into few devices or one device. For example, file storage—such as the virtual machine image file storage 230—may be included in or separate from a file format management device. A computing device 210 may not be included in some implementations, and input—such as requests—may be received directly by a file format management device. Other configurations of a system for managing file formats may also be used.

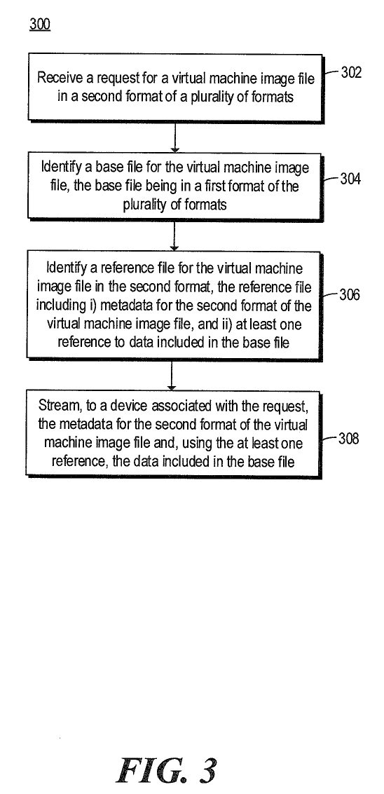

FIG. 3 is a flowchart of an example method 300 for managing virtual machine image file formats. The method 300 may be performed by a computing device, such as a computing device described in FIG. 1. Other computing devices may also be used to execute method 300. Method 300 may be implemented in the form of executable instructions stored on a machine-readable storage medium, such as the storage medium 130, and/or in the form of electronic circuitry, such as an FPGA or ASIC.

A request is received for a virtual machine image file in a second format of a plurality of formats (302). For example, the second format may be a vdi format for a particular virtual machine image file, which may be requested by or on behalf of a host computing device designed to deploy virtual machines.

A base file for the virtual machine image file is identified, the base file being in a first format of the plurality of formats (304). In some implementations, the base file is identified using a file map, e.g., a previously generated mapping of virtual machine image files to their base file format. For example, the base file for the particular virtual machine image file may be in the vmdk format.

A reference file for the virtual machine image file in the second format is identified, the reference file including i) metadata for the second format of the virtual machine image file, and ii) at least one reference to data included in the base file (306). For example, a reference file for the vdi format of the particular virtual machine image file may be identified. The vdi reference file may include metadata, such as a header and/or footer that includes information relevant to the vdi format, and references to the memory location of the underlying data for the base file that is stored in the vmdk format.

The metadata for the second format of the virtual machine image file and the data included in the base file is streamed to a device associated with the request using the at least one reference (308). For example, the vdi header and/or footer may be streamed to the device that requested the vdi format of the particular virtual machine image. In addition, the underlying data that was stored for the vmdk format and referenced by the vdi reference file may also be streamed to the device that requested the virtual machine image file. In this example, data is streamed from one device to another, e.g., using a wireless and/or wired network, in a manner designed to allow the recipient of the image file to deploy the image on the receiving device. This may be implemented, for example, in a cloud computing system that provides virtual machine image files for deploying a variety of different types of virtual machines and configurations in a variety of formats.

In some implementations, a new format may be created for a virtual machine image file based on the base file. For example, the new format may be generated by creating a new format reference file that includes metadata for the new format and at least one reference to a location of the data included in the base file. In some implementations, a file map may be generated that identifies a particular format as the base file for the virtual machine image file.

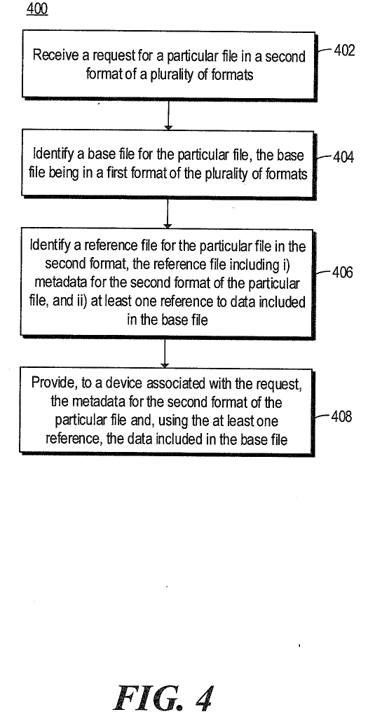

FIG. 4 is a flowchart of an example method 400 for the management of file formats. The method 400 may be performed by a computing device, such as a computing device described in FIG. 1. Other computing devices may also be used to execute method 400. Method 400 may be implemented in the form of executable instructions stored on a machine-readable storage medium, such as the storage medium 130, and/or in the form of electronic circuitry, such as an FPGA or ASIC.

A request is received for a particular file in a second format of a plurality of formats (402). For example, the particular file may be a digital word processing document in a rich text format (RTF). The plurality of formats may include any number of different types of digital document formats.

A base file is identified for the particular file, the base file being in a first format of the plurality of formats (404). The first format may be, for example, a txt format. The base file may be identified, in some implementations, using a file map that maps digital documents to their corresponding base files.

A reference file for the particular file in the second format is identified, the reference file including i) metadata for the second format of the particular file, and ii) at least one reference to data included in the base file (406). For example, a reference file for the RTF format of the digital document file may be identified. The RTF reference file may include metadata, such as a header and/or footer that includes information relevant to the RTF format, such as font and formatting information, and references to the memory location of the underlying data for the base file that is stored in the txt format.

The metadata for the second format of the particular file and the data included in the base file is provided to a device associated with the request using the at least one reference (408). For example, the RTF header and any other metadata included in the RTF reference file may be provided to the requesting device along with the underlying data that was stored in the txt format. The underlying data may be obtained and provided using the references included in the RTF reference file, e.g., pointers to memory address ranges where the underlying data stored for the txt file is stored.

As with method 300, in some implementations of method 400 a new format may be created for a particular file based on the base file. For example, the new format may be generated by creating a new format reference file that includes metadata for the new format and at least one reference to a location of the data included in the base file.

While the methods 300 and 400 are described with respect to a single computing device, various portions of the methods may be performed by other computing devices. For example, one computing device may be responsible for generating reference files, while another computing device may be responsible for receiving and responding to requests for files in a particular format.

The foregoing disclosure describes a number of example implementations for managing file formats. As detailed above, examples provide a mechanism for using metadata and references to a single format to create reference files for other formats of the same underlying data.

We claim:

1. A computing device for managing file formats, the computing device comprising:
a hardware processor; and
a data storage device storing instructions that, when executed by the hardware processor, cause the hardware processor to:
identify a particular file having a first format;
generate a reference file for a second format of the particular file, the reference file including i) metadata for the second format of the particular file, and ii) at least one reference to a location of data included in the particular file; and
generate, for the particular file, a file map that identifies the first format as a base file for the particular file.

2. The computing device of claim 1, wherein the instructions further cause the hardware processor to:
receive a request for the particular file in the second format;
identify the base file for the particular file using the file map of the particular file;
obtain the data included in the base file using the at least one reference included in the reference file; and
provide, in response to the request, the metadata for the second format of the particular file and the data obtained from the base file.

3. The computing device of claim 1, wherein the instructions further cause the hardware processor to:
receive a request for the particular file in the first format;
identify the base file for the particular file using the file map of the particular file; and
provide, in response to the request, the data included in the particular file.

4. The computing device of claim 1, wherein the metadata includes at least one of:
a header including data relevant to the second format; or
a footer including data relevant to the second format.

5. The computing device of claim 1, wherein:
the particular file is a virtual machine image file; and
the second format is a raw format for the virtual machine image file.

6. A method for managing file formats, implemented by a hardware processor, the method comprising:
receiving a request for a particular file in a second format of a plurality of formats;
identifying a base file for the particular file, the base file being in a first format of the plurality of formats;
identifying a reference file for the particular file in the second format, the reference file including i) metadata for the second format of the particular file, and ii) at least one reference to data included in the base file; and
providing, to a device associated with the request, the metadata for the second format of the particular file and, using the at least one reference, the data included in the base file.

7. The method of claim 6, further comprising:
creating a new format for the particular file based on the base file.

8. The method of claim 7, wherein the new format is created by generating a new format reference file that includes metadata for the new format and at least one reference to a location of the data included in the base file.

9. The method of claim 6, further comprising:
generating a file map that identifies the first format as the base file for the particular file.

10. The method of claim 6, wherein the base file is identified using a file map that identifies the first format as the base file for the particular file.

11. The method of claim 6, wherein:
the particular file is a virtual machine image file; and
the first format is a raw format for the virtual machine image file.

12. A non-transitory machine-readable storage medium encoded with instructions executable by a hardware processor of a computing device for managing file formats, the machine-readable storage medium comprising instructions to cause the hardware processor to:
receive a request for a virtual machine image file in a second format of a plurality of formats;
identify a base file for the virtual machine image file, the base file being in a first format of the plurality of formats;
identify a reference file for the virtual machine image file in the second format, the reference file including i) metadata for the second format of the virtual machine image file, and ii) at least one reference to data included in the base file; and
stream, to a device associated with the request, the metadata for the second format of the virtual machine image file and, using the at least one reference, the data included in the base file.

13. The storage medium of claim 12, wherein the instructions further cause the hardware processor to:
obtain the data included in the base file using the at least one reference included in the reference file.

14. The storage medium of claim 12, wherein the instructions further cause the hardware processor to:
create a new format for the virtual machine image file based on the base file.

15. The storage medium of claim 14, wherein the new format is created by generating a new format reference file that includes metadata for the new format and at least one reference to a location of the data included in the base file.

16. The storage medium of claim 12, wherein the instructions further cause the hardware processor to:
generate a file map that identifies the first format as the base file for the virtual machine image file.

17. The storage medium of claim 12, wherein the base file is identified using a file map that identifies the first format as the base file for the virtual machine image file.

18. The storage medium of claim 12, wherein the first format is a raw format for the virtual machine image file.
